(19) United States
(12) Patent Application Publication
(10) Pub. No.: US 2020/0050184 A1
(43) Pub. Date: Feb. 13, 2020

(54) WIND VELOCITY FORCE FEEDBACK

(71) Applicant: SZ DJI TECHNOLOGY CO., LTD., Shenzhen (CN)

(72) Inventors: Xiangpeng MIAO, Shenzhen (CN); Huasen ZHANG, Shenzhen (CN)

(21) Appl. No.: 16/657,633

(22) Filed: Oct. 18, 2019

Related U.S. Application Data
(63) Continuation of application No. PCT/CN2017/081499, filed on Apr. 21, 2017.

(51) Int. Cl. G05D 1/00; G06F 3/01; G05B 13/04; G06F 3/038; B64C 19/02; F03D 7/04; F03D 17/00

(52) U.S. Cl. CPC G05D 1/005; G06F 3/016; G05B 13/04; B64C 2201/14; B64C 19/02; F03D 7/046; F03D 17/00; G06F 3/038

(57) ABSTRACT

A method for adjusting feedback of a remote controller includes obtaining wind data that corresponds to wind incident on a movable object controlled by the remote controller, mapping the wind data to one or more axes of an input device of the remote controller that correspond to one or more axes of the movable object, respectively, and adjusting a feedback of the input device with respect to one of the one or more axes of the input device based at least in part on the wind data mapped to the one or more axes of the input device. The wind data includes wind velocity data along the one or more axes of the movable object.

### CROSS-REFERENCE TO RELATED APPLICATION

This application is a continuation of International Application No. PCT/CN2017/081499, filed Apr. 21, 2017, the entire content of which is incorporated herein by reference.

### TECHNICAL FIELD

The disclosed embodiments relate generally to adjusting a resistance force of a movable object controller and more particularly, but not exclusively, to adjusting a resistance force based on wind incident on a movable object.

### BACKGROUND

When a movable object such as an unmanned aerial vehicle (UAV) is flying in wind, the speed of movement of the moveable object is affected by the speed and direction of the wind. For a UAV to move at a given speed, a greater amount of power is required to control motion of the UAV when the UAV is flying into a headwind (wind blowing in a direction that is against the direction of travel of the UAV) than when the UAV is flying in a tailwind (wind blowing in a direction that is in the direction of travel of the UAV). As a user provides input to a remote controller device in order to control the speed of movement of a UAV, wind conditions may cause the movable object to move in a way that does not align with the expectations of the user.

### SUMMARY

There is a need for systems and methods for adjusting feedback of a remote controller to indicate to a user the effect of wind on a movable object that is controlled by the remote controller.

In accordance with some embodiments, a method for adjusting feedback of a remote controller configured to control movement of a movable object comprises obtaining wind data that corresponds to wind incident on the movable object. The wind data comprises wind velocity data along one or more axes of the movable object. The method further comprises mapping the wind data to one or more axes of an input device of the remote controller. The one or more axes of the input device correspond to the one or more axes of the movable object. The method additionally comprises adjusting a feedback of the input device with respect to each of the one or more axes of the input device. The adjustment is based at least in part on the wind data mapped to the one or more axes of the input device.

In accordance with some embodiments, a system for adjusting feedback of a remote controller configured to control movement of a movable object comprises a memory, one or more processors coupled to the memory, and one or more programs. The one or more programs are stored in the memory and configured to be executed by the one or more processors. The one or more programs include instructions for obtaining wind data that corresponds to wind incident on the movable object. The wind data comprises wind velocity data along one or more axes of the movable object. The one or more programs further include instructions for mapping the wind data to one or more axes of an input device of the remote controller. The one or more axes of the input device correspond to the one or more axes of the movable object. The one or more programs additionally include instructions for adjusting a feedback of the input device with respect to each of the one or more axes of the input device. The adjustment is based at least in part on the wind data mapped to the one or more axes of the input device.

In accordance with some embodiments, a computer readable storage medium stores one or more programs for adjusting feedback of a remote controller configured to control movement of a movable object. The one or more programs comprise instructions which, when executed, cause a device to obtain wind data that corresponds to wind incident on the movable object. The wind data comprises wind velocity data along one or more axes of the movable object. The one or more programs additionally comprise instructions which, when executed, map the wind data to one or more axes of an input device of the remote controller. The one or more axes of the input device correspond to the one or more axes of the movable object. The one or more programs additionally comprise instructions which, when executed, adjust a feedback of the input device with respect to each of the one or more axes of the input device. The adjustment is based at least in part on the wind data mapped to the one or more axes of the input device.

In accordance with some embodiments, a remote controller is configured to control movement of a movable object. The remote controller comprises an input device, a storage device, one or more processors coupled to the input device and the storage device, and one or more programs for adjusting feedback of the remote controller. The one or more programs are stored in the storage device and configured to be executed by the one or more processors. The one or more programs include instructions for obtaining wind data that corresponds to wind incident on the movable object. The wind data comprises wind velocity data along one or more axes of the movable object. The one or more programs additionally comprise instructions for mapping the wind data to one or more axes of an input device of the remote controller. The one or more axes of the input device correspond to the one or more axes of the movable object. The one or more programs additionally comprise instructions for adjusting a feedback of the input device with respect to each of the one or more axes of the input device. The adjustment is based at least in part on the wind data mapped to the one or more axes of the input device.

### BRIEF DESCRIPTION OF THE DRAWINGS

FIG. 1 illustrates a movable object environment, in accordance with some embodiments.

FIG. 2 is a block diagram of an illustrative movable object, in accordance with some embodiments.

FIG. 3 is a block diagram of an illustrative remote controller for controlling movement of a movable object, in accordance with some embodiments.

FIG. 4 illustrates a remote control, in accordance with some embodiments.

FIGS. 5A-5H illustrate adjustments to the motion of movable object that correspond to navigation inputs provided at a remote control, in accordance with some embodiments.

FIGS. 6A-6C illustrate an input device that includes an electromagnetic resistance assembly for adjusting a resistance force that resists movement of a lever, in accordance with some embodiments.

FIG. 7 illustrates an input device in which a resistance assembly is coupled to a rotating shaft, in accordance with some embodiments.

FIG. 8 illustrates an input device in which a resistance assembly is coupled to a reset member, in accordance with some embodiments.

FIGS. 9A-9B illustrate the difference between an expected movement trajectory of a movable object and an actual movement trajectory of the movable object when the movable object is flying into a headwind, in accordance with some embodiments.

FIGS. 10A-10B illustrate the difference between an expected movement trajectory of a movable object and an actual movement trajectory of the movable object when the movable object is flying in a tailwind, in accordance with some embodiments.

FIG. 11 illustrates wind incident on a movable object that affects the movement trajectory of the movable object along multiple axes, in accordance with some embodiments.

FIGS. 12A-12D illustrate use of an expected status parameter and an actual status parameter to obtain wind data, in accordance with some embodiments.

FIGS. 13A-13D are flow diagrams illustrating a method for adjusting feedback of a movable object controller that is remote from a movable object, in accordance with some embodiments.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

When a remote controller is used to provide control signals to control the movement of a movable object, such as a UAV, the resulting movement of the UAV will depend on characteristics of wind incident on the UAV relative to the expected movement of the UAV. Movement of the UAV may be greater than expected when the UAV is flying in a tailwind and the movement may be less than expected when the UAV is flying in a headwind. To provide the user with information about the effect of the wind on movement of the UAV, feedback (e.g., haptic feedback) is provided at a remote controller to simulate the effect of the wind on the UAV. In this way, the user is provided with an intuitive sense of the effect of the wind on the flight of the UAV. This enables the user to compensate for the effect of the wind when controlling the movement of the UAV.

The following description uses a UAV as an example of a movable object. UAVs include, e.g., fixed-wing aircrafts and rotary-wing aircrafts such as helicopters, quadcopters, and aircraft having other numbers and/or configurations of rotors. It will be apparent to those skilled in the art that other types of movable objects may be substituted for UAVs as described below.

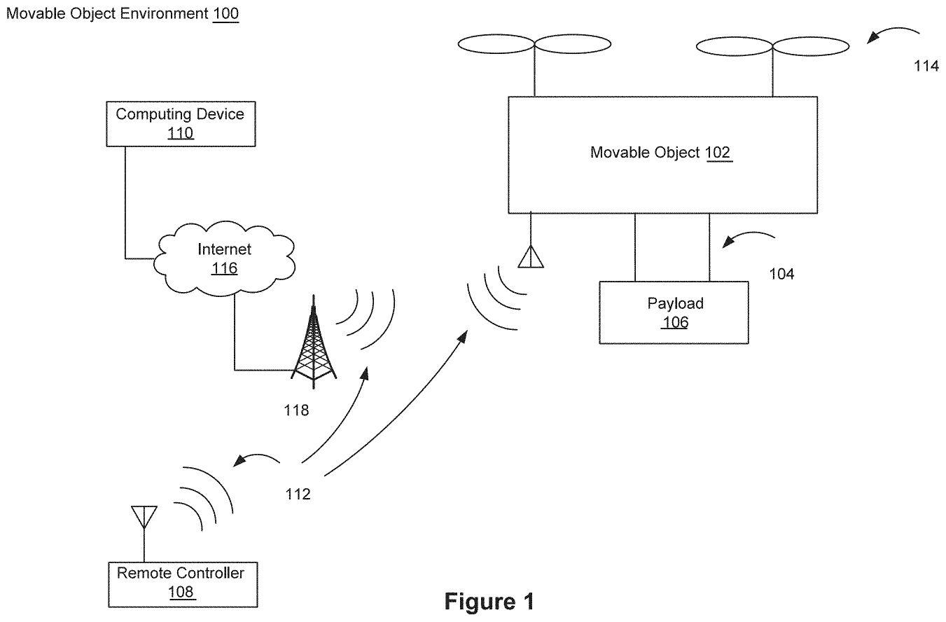

FIG. 1 illustrates a movable object environment 100, in accordance with some embodiments. The movable object environment 100 includes a movable object 102. In some embodiments, the movable object 102 includes a carrier 104 and/or a payload 106.

In some embodiments, the carrier 104 is used to couple a payload 106 to movable object 102. In some embodiments, the carrier 104 includes an element (e.g., a gimbal and/or damping element) to isolate the payload 106 from movement of the movable object 102 and/or the movement mechanism 114. In some embodiments, the carrier 104 includes an element for controlling movement of the payload 106 relative to the movable object 102.

In some embodiments, the payload 106 is coupled (e.g., rigidly coupled) to the movable object 102 (e.g., coupled via the carrier 104) such that the payload 106 remains substantially stationary relative to the movable object 102. For example, the carrier 104 is coupled to the payload 106 such that the payload is not movable relative to the movable object 102. In some embodiments, the payload 106 is mounted directly to the movable object 102 without requiring the carrier 104. In some embodiments, the payload 106 is located partially or fully within the movable object 102.

In some embodiments, a remote controller 108 communicates with the movable object 102, e.g., to provide control instructions to the movable object 102 and/or to display information received from the movable object 102. Although the remote controller 108 is typically a portable (e.g., handheld) device, the remote controller 108 need not be portable. In some embodiments, the remote controller 108 is a dedicated control device (e.g., for the movable object 102), a laptop computer, a desktop computer, a tablet computer, a gaming system, a wearable device (e.g., glasses, a glove, and/or a helmet), a microphone, a portable communication device (e.g., a mobile telephone) and/or a combination thereof.

In some embodiments, a computing device 110 communicates with the movable object 102. The computing device 110 is, e.g., a server computer, desktop computer, a laptop computer, a tablet, or another electronic device. In some embodiments, the computing device 110 is a base station that communicates (e.g., wirelessly) with the movable object 102 and/or the remote controller 108. In some embodiments, the computing device 110 provides data storage, data retrieval, and/or data processing operations, e.g., to reduce the processing power requirements and/or data storage requirements of the movable object 102 and/or the remote controller 108. For example, the computing device 110 is communicatively connected to a database and/or the computing device 110 includes a database. In some embodiments, the computing device 110 is used in lieu of or in addition to the remote controller 108 to perform any of the operations described with regard to the remote controller 108.

In some embodiments, the movable object 102 communicates with a remote controller 108 and/or a computing device 110, e.g., via wireless communications 112. In some embodiments, the movable object 102 receives information from the remote controller 108 and/or the computing device 110. For example, information received by the movable object 102 includes, e.g., control instructions for controlling parameters of the movable object 102. In some embodiments, the movable object 102 transmits information to the remote controller 108 and/or the computing device 110. For example, information transmitted by the movable object 102 includes, e.g., images and/or video captured by the movable object 102.

In some embodiments, communications between the computing device 110, the remote controller 108 and/or the movable object 102 are transmitted via a network (e.g., Internet 116) and/or a wireless signal transmitter (e.g., a long range wireless signal transmitter), such as a cellular tower 118. In some embodiments, a satellite (not shown) is a component of Internet 116 and/or is used in addition to or in lieu of the cellular tower 118.

In some embodiments, information communicated between the computing device 110, the remote controller 108 and/or the movable object 102 include movement control instructions. The movement control instructions include, e.g., navigation instructions for controlling navigational parameters of the movable object 102 such as position, orientation, attitude, and/or one or more movement characteristics (e.g., velocity and/or acceleration for linear and/or angular movement) of the movable object 102, the carrier 104, and/or the payload 106. In some embodiments, the movement control instructions include instructions for directing movement of one or more of the movement mechanisms 114. For example, the movement control instructions are used to control flight of a UAV.

In some embodiments, the movement control instructions include information for controlling operations (e.g., movement) of the carrier 104. For example, the movement control instructions are used to control an actuation mechanism of the carrier 104 so as to cause angular and/or linear movement of the payload 106 relative to the movable object 102. In some embodiments, the movement control instructions adjust movement of the movable object 102 with up to six degrees of freedom.

In some embodiments, the movement control instructions are used to adjust one or more operational parameters for the payload 106. For example, the movement control instructions include instructions for adjusting a focus parameter and/or an orientation of the payload 106 to track a target.

In some embodiments, when the movement control instructions are received by the movable object 102, the movement control instructions change parameters of and/or are stored by the memory 204.

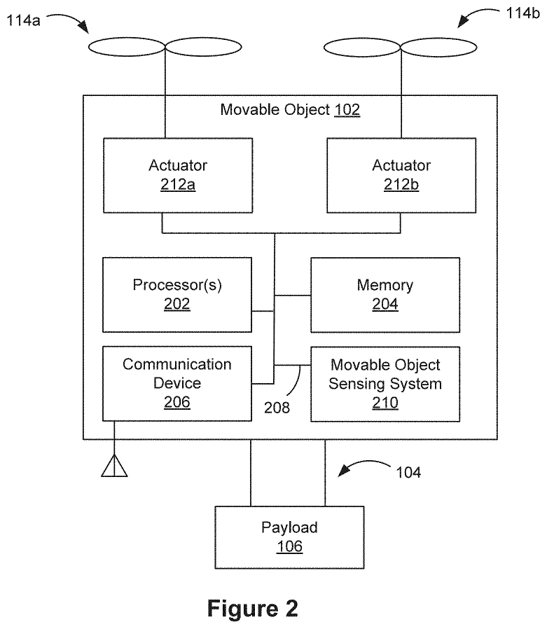

FIG. 2 is an exemplary block diagram of a movable object 102, in accordance with some embodiments. The movable object 102 typically includes one or more processor(s) 202, a memory 204, a communication device 206, a movable object sensing system 210, and a communication bus 208 for interconnecting these components.

In some embodiments, the movable object 102 is a UAV and includes components to enable flight and/or flight control. For example, the movable object 102 includes movement mechanisms 114 and/or movable object actuators 212, which are optionally interconnected with one or more other components of the movable object 102 via the communication bus 208. Although the movable object 102 is depicted as an aircraft, this depiction is not intended to be limiting, and any suitable type of movable object can be used.

In some embodiments, the movable object 102 includes movement mechanisms 114 (e.g., propulsion units). Although the plural term “movement mechanisms” is used herein for convenience of reference, “movement mechanisms 114” refers to a single movement mechanism (e.g., a single propeller) or multiple movement mechanisms (e.g., multiple rotors). The movement mechanisms 114 include one or more movement mechanism types such as rotors, propellers, blades, engines, motors, wheels, axles, magnets, nozzles, and so on. The movement mechanisms 114 are coupled to movable object 102 at, e.g., the top, bottom, front, back, and/or sides. In some embodiments, the movement mechanisms 114 of a single movable object 102 include multiple movement mechanisms (e.g., 114a, 114b) of the same type. In some embodiments, the movement mechanisms 114 of a single movable object 102 include multiple movement mechanisms with different movement mechanism types. The movement mechanisms 114 are coupled to the movable object 102 (or vice-versa) using any suitable means, such as support elements (e.g., drive shafts) and/or other actuating elements (e.g., the movable object actuators 212). For example, one or more movable object actuators 212 (e.g., 212a, 212b of FIG. 2) receives control signals from the processor(s) 202 (e.g., via the control bus 208) that activate the movable object actuator 212 to cause movement of respective movement mechanisms 114 (e.g., 114a, 114b of FIG. 2). In some embodiments, the processor(s) 202 include an electronic speed controller that provides control signals to a movable object actuator 212.

In some embodiments, the movement mechanisms 114 enable the movable object 102 to take off vertically from a surface or land vertically on a surface without requiring any horizontal movement of the movable object 102 (e.g., without traveling down a runway). In some embodiments, the movement mechanisms 114 are operable to permit the movable object 102 to hover in the air at a specified position and/or orientation. In some embodiments, one or more of the movement mechanisms 114 are controllable independently of one or more of the other movement mechanisms 114. For example, when the movable object 102 is a quadcopter, each rotor of the quadcopter is controllable independently of the other rotors of the quadcopter. In some embodiments, multiple movement mechanisms 114 are configured for simultaneous movement.

In some embodiments, the movement mechanisms 114 include multiple rotors that provide lift and/or thrust to the movable object 102. The multiple rotors are actuated to provide, e.g., vertical takeoff, vertical landing, and/or hovering capabilities to the movable object 102. In some embodiments, one or more of the rotors spin in a clockwise direction, while one or more of the rotors spin in a counterclockwise direction. For example, the number of clockwise rotors is equal to the number of counterclockwise rotors. In some embodiments, the rotation rate of each of the rotors is independently variable, e.g., for controlling the lift and/or thrust produced by each rotor, and thereby adjusting the spatial disposition, velocity, and/or acceleration of the movable object 102 (e.g., with respect to up to three degrees of translation and/or up to three degrees of rotation).

In some embodiments, the memory 204 stores one or more programs (e.g., sets of instructions), modules, and/or data structures, collectively referred to as “elements” herein. In some embodiments, one or more elements described with regard to the memory 204 are stored and/or executed by the remote controller 108, the computing device 110, and/or another device.

In some embodiments, the memory 204 stores a controlling system configuration that includes one or more system settings (e.g., as configured by a manufacturer, administrator, and/or user), control instructions, and or instructions for adjusting system settings and/or operation (e.g., based on received control instructions).

In some embodiments, the memory 204 includes instructions for determining an expected status parameter of the movable object 102. In some embodiments, instructions for determining an expected status parameter of the movable object 102 include instructions for determining an expected velocity based on one or more received motion control instructions, based on a power level signal provided to one or more actuators 212, and/or based on a rotation speed of one or more movement mechanisms 114 (e.g., as sensed by one or more sensors of movable object sensing system 210).

In some embodiments, the memory 204 includes instructions for determining an actual status parameter of the movable object 102. For example, the instructions for determining an actual status parameter of the movable object 102 include instructions for determining an actual movement trajectory based on data obtained from data output of one or more sensors of movable object sensing system 210. Examples of actual status parameters of the movable object include a movement trajectory of the movable object 102, a velocity of the movable object 102, a distance traversed by the movable object 102 over a defined period of time, and/or an attitude angle of the movable object 102. In some embodiments, the instructions for determining an actual status parameter of the movable object 102 include instructions for determining a status parameter using one or more sensors of movable object sensing system 210.

The above identified elements (e.g., modules and/or programs including sets of instructions) need not be implemented as separate software programs, procedures or modules, and thus various subsets of these modules may be combined or otherwise re-arranged in various embodiments. In some embodiments, the memory 204 stores a subset of the modules and data structures identified above. Furthermore, the memory 204 may store additional modules and data structures not described above. In some embodiments, the programs, modules, and data structures stored in the memory 204, or a non-transitory computer readable storage medium of the memory 204, provide instructions for implementing respective operations in the methods described below. In some embodiments, some or all of these modules may be implemented with specialized hardware circuits that subsume part or all of the module functionality. One or more of the above identified elements may be executed by one or more of the processor(s) 202 of the movable object 102. In some embodiments, one or more of the above identified elements is executed by one or more processors of a device remote from the movable object 102, such as processor(s) of the remote controller 108 and/or processor(s) of the computing device 110.

The communication device 206 enables communication with the remote controller 108 and/or the computing device 110, e.g., via the wireless signals 112. The communication device 206 includes, e.g., transmitters, receivers, and/or transceivers for wireless communication. In some embodiments, the communication is one-way communication, such that data is only received by the movable object 102 from the remote controller 108 and/or the computing device 110, or vice-versa. In some embodiments, communication is two-way communication, such that data is transmitted in both directions between the movable object 102 and the remote controller 108 and/or the computing device 110. In some embodiments, the movable object 102, the remote controller 108, and/or the computing device 110 are connected to the Internet 116 or other telecommunications network, e.g., such that data generated by the movable object 102, the remote controller 108, and/or the computing device 110 is transmitted to a server for data storage and/or data retrieval (e.g., for display by a website).

In some embodiments, the sensing system 210 of the movable object 102 includes one or more sensors. In some embodiments, one or more sensors of the movable object sensing system 210 are mounted to the exterior, located within, or otherwise coupled to the movable object 102. In some embodiments, one or more sensors of the movable object sensing system 210 are components of the carrier 104 and/or the payload 106. Where sensing operations are described herein as being performed by the movable object sensing system 210, it will be recognized that such operations are optionally performed by one or more sensors of the carrier 104 or the payload 106 in addition to or in lieu of one or more sensors of the movable object sensing system 210.

In some embodiments, the movable object sensing system 210 includes one or more location sensors (e.g., Global Positioning System (GPS) sensors), motion sensors (e.g., accelerometers), rotation sensors (e.g., gyroscopes), inertial sensors, proximity sensors (e.g., infrared sensors) and/or weather sensors (e.g., pressure sensor, temperature sensor, moisture sensor, and/or wind sensor). For example, the movable object sensing system 210 includes an anemometer that outputs wind speed and/or direction information. In some embodiments, the movable object 102, remote controller 108, and/or computing system 110 receives wind speed and/or direction data from an anemometer that is remote from movable object 102 (e.g., an anemometer mounted at a ground station and communicatively coupled to computer 110).

In some embodiments, the movable object sensing system 210 includes an image sensor. For example, the movable object sensing system 210 includes an image sensor that is a component of an imaging device, such as a camera. In some embodiments, the movable object sensing system 210 includes multiple image sensors, such as a pair of image sensors for stereographic imaging (e.g., a left stereographic image sensor and a right stereographic image sensor).

In some embodiments, the movable object sensing system 210 includes one or more audio transducers. For example, an audio detection system includes an audio output transducer (e.g., a speaker) and/or an audio input transducer (e.g., a microphone, such as a parabolic microphone). In some embodiments, microphone and a speaker are used as components of a sonar system. A sonar system is used, for example, to provide a three-dimensional map of the surroundings of the movable object 102.

In some embodiments, the movable object sensing system 210 includes one or more infrared sensors. In some embodiments, a distance measurement system for measuring a distance from the movable object 102 to an object or surface includes one or more infrared sensors, such a left infrared sensor and a right infrared sensor for stereoscopic imaging and/or distance determination.

In some embodiments, sensing data generated by one or more sensors of the movable object sensing system 210 and/or information determined based on sensing data from one or more sensors of the movable object sensing system 210 is used for depth detection. For example, the image sensor, the audio sensor, and/or the infrared sensor (and/or pairs of such sensors for stereo data collection) are used to determine a distance from the movable object 102 to another object, such as a target, an obstacle, and/or terrain.

In some embodiments, sensing data generated by one or more sensors of the movable object sensing system 210 and/or information determined based on sensing data from one or more sensors of the movable object sensing system 210 are transmitted to the remote controller 108 and/or the computing device 110 (e.g., via the communication device 206). In some embodiments, data generated by one or more sensors of the movable object sensing system 210 and/or information determined based on sensing data from one or more sensors of the movable object sensing system 210 is stored by the memory 204.

In some embodiments, the movable object 102, the remote controller 108, and/or the computing device 110 use sensing data generated by sensors of the sensing system 210 to determine information such as a position of the movable object 102, an attitude of the movable object 102, movement characteristics of the movable object 102 (e.g., angular velocity, angular acceleration, translational velocity, translational acceleration and/or direction of motion along one or more axes), and/or proximity of the movable object 102 to potential obstacles, targets, weather conditions, locations of geographical features and/or locations of manmade structures.

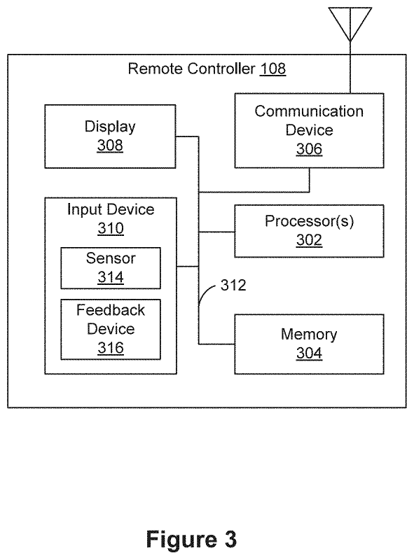

FIG. 3 is a block diagram of an exemplary remote controller 108 for controlling movement of a movable object 102, in accordance with some embodiments. Remote controller 108 includes, e.g., one or more processor(s) 302, memory 304, a communication device 306, a display 308, and/or an input device 310, and a communication bus 312 for interconnecting these components.

In some embodiments, the memory 304 is a storage device that stores instructions for one or more elements (e.g., one or more programs). In some embodiments, the memory 304 includes instructions for determining an expected status parameter of the movable object 102. For example, the memory 304 includes instructions for determining an expected status parameter of the movable object 102 using control instructions generated by the remote controller 108 based on input received at the input device 310. In some embodiments, the memory 304 includes instructions for determining a status parameter of the movable object 102 based on data, such as sensor output data, transmitted from the movable object 102 to the remote controller 108.

In some embodiments, the memory 304 includes instructions for adjusting feedback of input device 310, e.g., by adjusting feedback provided by a feedback device 316 of input device 310.

The input device 310 receives user input to control aspects of the movable object 102, the carrier 104, the payload 106, and/or a component thereof. Such aspects include, for example, attitude, position, orientation, velocity, acceleration, navigation, and/or tracking. In some embodiments, the input device 310 is manipulated by a user to provide control instructions for controlling the navigation of the movable object 102. For example, the magnitude of a change in position of an input device 310 of the remote controller 108 is used to adjust a magnitude of velocity, acceleration, change in orientation, or other aspect of the movement of the movable object 102.

In some embodiments, the input device 310 includes one or more mechanical input assemblies (e.g., joystick, analog stick, or other control stick; button; knob; dial; or pedal) and/or virtual controls (e.g., controls displayed on a touch-screen interface).

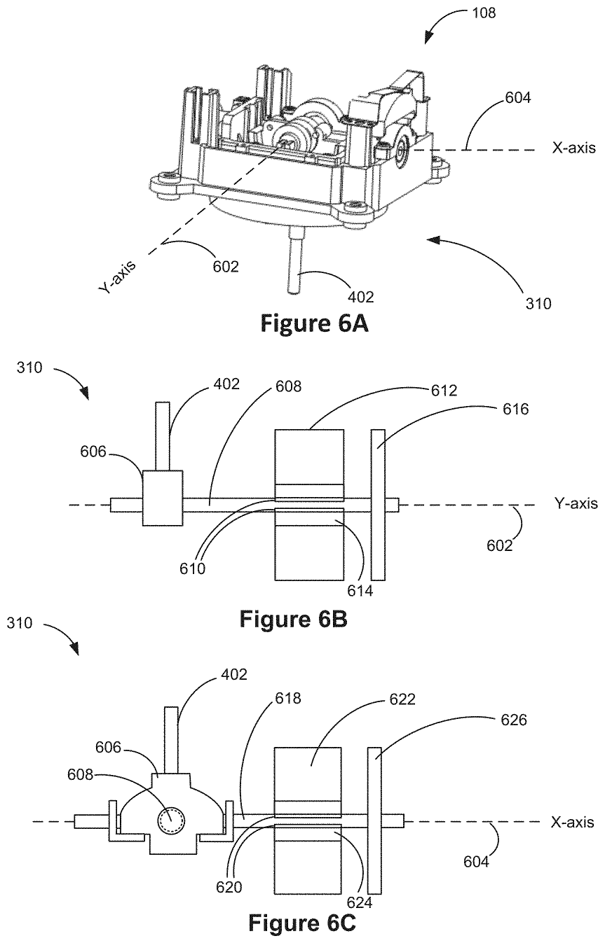

In some embodiments, the input device 310 includes a feedback device 316, such as a haptic device and/or a resistance force adjustment mechanism. In some embodiments, the feedback device 316 causes an adjustment to a resistance force (such as an adjustment to increase resistance to operation of the input device 310, e.g., by making the input device 310 more difficult to move in one or more directions, and/or an adjustment to decrease resistance to operation of the input device 310, e.g., by making the input device 310 less difficult to move in one or more directions). The input device 310 includes one or more components for adjusting the resistance force that resists input movement. For example, the input device 310 includes one or more resistance assemblies as described further below with regard to FIGS. 6A-6C, 7 and 8.

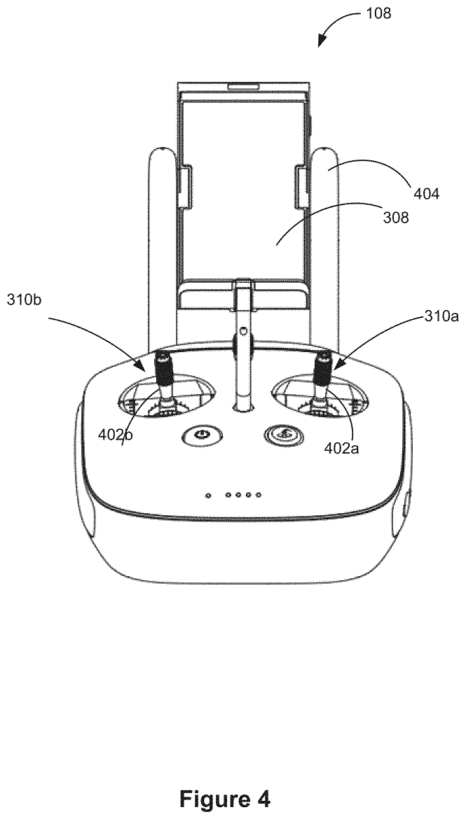

In some embodiments, the input device 310 includes a sensor 314 configured to detect motion of a mechanical input device (e.g., a lever 402 as shown in FIG. 4). The sensor 314 is, for example, a Hall sensor, a potentiometer, a strain gauge, an optical sensor, and/or a piezoelectric sensor. In some embodiments, output generated by sensor 314 is received by the processor(s) 302 and/or stored by the memory 304.

In some embodiments, a display 308 of the remote controller 108 displays information from the memory 304, the processor(s) 302, or information received from the movable object 102, such as data from movable object sensing system 210 (e.g., images captured by an imaging device), the memory 204, and/or another system of the movable object 102. For example, the display 308 displays information about the movable object 102, the carrier 104, and/or the payload 106, such as position, attitude, orientation, movement characteristics of the movable object 102. In some embodiments, information displayed by the display 308 of the remote controller 108 includes tracking data (e.g., a graphical tracking indicator applied to a representation of a target), and/or indications of control data transmitted to the movable object 102. In some embodiments, information displayed by the display 308 of the remote controller 108 is displayed in substantially real-time as information is received from the movable object 102 and/or as image data is acquired.

In some embodiments, the display 308 of the remote controller 108 is a touchscreen display. In some embodiments, a touchscreen display is configured to display a user interface including controls for controlling movement of the movable object 102.

In some embodiments, the display 308 and/or the input device 310 of the remote controller 108 are included in one or more peripheral electronic devices that are communicatively coupled to the remote controller 108, such as a mobile telephone or other portable computing device.

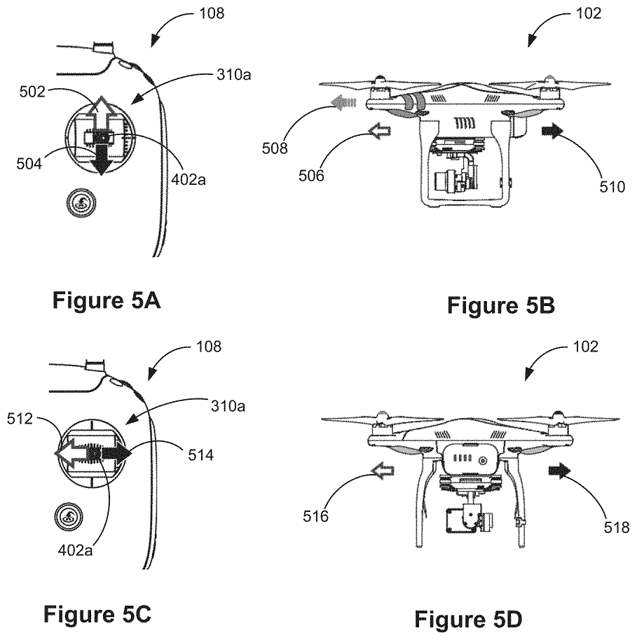

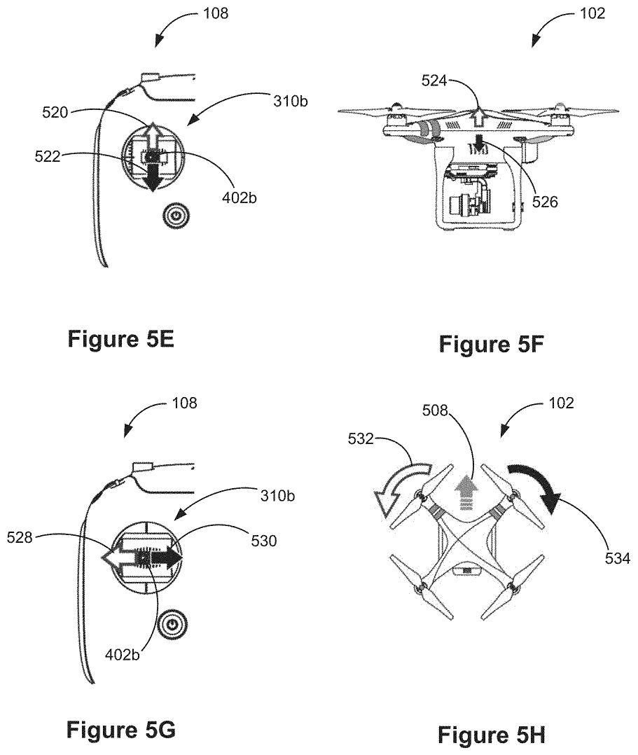

FIG. 4 illustrates an exemplary remote controller 108, in accordance with some embodiments. The input device 310 of the remote controller 108 illustrated in FIG. 4 includes a right control stick input device 310a and a left control stick input device 310b. The right control stick input device 310a includes a right lever 402a and the left control stick input device 310b includes a left lever 402b. In some embodiments, the right lever 402a and/or the left lever 402b is adjustable in two directions along a first axis (e.g., up and down along a vertical axis of the remote controller 108) and in two directions along a second axis (e.g., right and left along a horizontal axis of the remote controller 108 that is perpendicular to the vertical axis), as described further with regard to FIGS. 5A-5H. In some embodiments, input assemblies 310 are configured for single directional, bi-directional, 360° , and/or uni-directional input. In some embodiments, the display 308 is a peripheral electronic device (e.g., cellular telephone) mounted to remote controller 108 via a mounting structure 404.

FIGS. 5A-5H illustrate adjustments to the motion of movable object 102 that correspond to navigation inputs provided at the right control stick input device 310a and the left control stick input device 310b of the remote controller 108.

Input received at the right control stick input device 310a along a vertical axis changes the forward and backward pitch of the movable object 102, as indicated at FIGS. 5A-5B. FIG. 5A illustrates input received at the right control stick input device 310a along a vertical axis of the remote controller 108: an upward input 502 (e.g., movement of the right lever 402a in an upward direction), indicated by a white arrow, and a downward input 504 (e.g., movement of the right lever 402a in a downward direction), indicated by a black arrow. FIG. 5B illustrates adjustments to the motion of the movable object 102 that correspond to adjustments to the right control stick input device 310a along the vertical axis. In response to the upward input 502 at the right control stick input device 310a, movable object 102 moves forward (in the direction of forward motion relative to the current orientation of movable object 102), as indicated by white arrow 506. Arrow 508 indicates the current orientation (and direction of forward motion) of movable object 102. In response to the downward input 504 at the right control stick input device 310a, the movable object 102 moves backward (e.g., in a direction opposite the direction of forward motion indicated by the arrow 508), as indicated by the black arrow 510.

Input received at the right control stick input device 310a along a horizontal axis changes the left and right pitch of the movable object 102, as indicated at FIGS. 5C-5D. FIG. 5C illustrates input received at the right control stick input device 310a along a horizontal axis of remote controller 108: a leftward input 512 (e.g., movement of the lever 402a in a leftward direction), indicated by a white arrow, and a rightward input 514 (e.g., movement of the lever 402a in a rightward direction), indicated by a black arrow. FIG. 5D illustrates adjustments to the motion of movable object 102 that correspond to adjustments to the right control stick input device 310a along the horizontal axis. In response to the leftward input 512 at the right control stick input device 310a, movable object 102 moves leftward (relative to the current orientation of movable object 102), as indicated by white arrow 516. In response to the rightward input 514 at the right control stick input device 310a, the movable object 102 moves backward (relative to the current orientation of movable object 102), as indicated by the black arrow 518.

In some embodiments, to provide an indication of wind direction and/or magnitude, feedback of the right control stick input device 310a is adjusted (e.g., a force that resists operation of the right control stick input device 310a is increased or decreased) along a direction of movement indicated by the arrow 502, 504, 512 and/or 514.

Input received at the left control stick input device 310b along a vertical axis changes the elevation the movable object 102, as indicated at FIGS. 5E-5F. FIG. 5E illustrates input received at the left control stick input device 310b along a vertical axis of the remote controller 108: an upward input 520 (e.g., movement of the left lever 402b in an upward direction), indicated by a white arrow, and a downward input 522 (e.g., movement of the left lever 402b in a downward direction), indicated by a black arrow. FIG. 5F illustrates adjustments to the motion of the movable object 102 that correspond to adjustments to the left control stick input device 310b along the vertical axis. In response to the upward input 520 at the control stick input device 310b, the movable object 102 moves upward as indicated by the white arrow 524. In response to the downward input 522 at the control stick input device 310b, the movable object 102 moves downward, as indicated by the black arrow 526.

Input received at the left control stick input device 310b along a horizontal axis changes the rudder and rotation of the movable object 102, as indicated at FIGS. 5G-5H. FIG. 5G illustrates input received at the left control stick input device 310b along a horizontal axis of the remote controller 108: a leftward input 528 (e.g., movement of the lever 402b in a leftward direction), indicated by a white arrow, and a rightward input 530 (e.g., movement of the lever 402b in a rightward direction), indicated by a black arrow. FIG. 5H illustrates adjustments to the motion of the movable object 102 that correspond to adjustments to the left control stick input device 310b along the horizontal axis. In response to the leftward input 528 at the control stick input device 310b, the movable object 102 rotates counter-clockwise (relative to the current orientation of movable object 102), as indicated by the white arrow 532. In response to the rightward input 530 at the control stick input device 310b, the movable object 102 rotates clockwise (relative to the current orientation of the movable object 102), as indicated by the black arrow 534.

In some embodiments, to provide an indication of wind direction and/or magnitude, feedback of left control stick input device 310b is adjusted (e.g., a force that resists operation of the left control stick input device 310b is increased or decreased) along a direction of movement indicated by the arrow 520, 522, 528 and/or 530.

FIGS. 6A-6C illustrate an input device 310 that includes an electromagnetic resistance assembly for adjusting a resistance force that resists movement of a lever 402, in accordance with some embodiments. The input device 310 is, for example, a control stick input device (e.g., the right control stick input device 310a or the left control stick input device 310b as described with regard to FIGS. 4 and 5A-5H). The input device 310 includes a lever 402 (e.g., the right lever 402a or the left lever 402b as described with regard to FIGS. 4 and 5A-5H). As illustrated in FIG. 6A, the lever 402 is configured to swivel about the y-axis 602 (e.g., for input along a vertical axis of remote controller 108) and about the x-axis 604 (e.g., for input along a horizontal axis of remote controller 108).

As illustrated in FIG. 6B, the lever 402 of the input device 310 is coupled via a coupling device 606 to a shaft 608 that is oriented along the y-axis 602. The coupling device 606 enables the lever 402 to swivel the shaft 608 about the y-axis 602 and to swivel a shaft 618 (shown in FIG. 6C) about the x-axis 604. One or more magnets 610 are coupled to the shaft 608. In some embodiments, an electromagnetic coil 612 is separated from magnets 610 by an air gap 614. Electrical current flowing through the electromagnetic coil 612 interacts with the one or more magnets 610 to adjust the resistance force that resists movement of lever 402 about y-axis 602 applied by a user of the remote controller 108. An encoder 616 provides information about the movement of the lever 402 about y-axis 602 to the processor 302 of the remote controller 108.

As illustrated in FIG. 6C, lever 402 of input device 310 is coupled via a coupling device 606 to a shaft 618 that is oriented along the x-axis 604. One or more magnets 620 are coupled to the shaft 618. In some embodiments, an electromagnetic coil 622 is separated from magnets 620 by an air gap 624. Electrical current flowing through the electromagnetic coil 622 interacts with the one or more magnets 620 to adjust the resistance force that resists movement of lever 402 about x-axis 604. An encoder 626 provides information about the movement of lever 402 about x-axis 604 to processor 302 of remote controller 108.

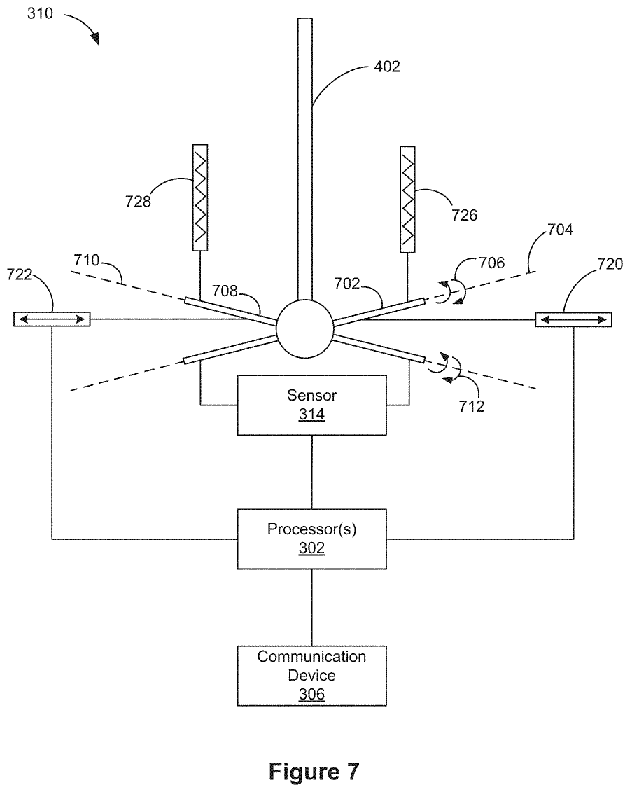

FIG. 7 illustrates an input device 310 in which a resistance assembly 720 is coupled to a rotating shaft 702, in accordance with some embodiments. In some embodiments, the input device 310 includes a lever 402 (such as the lever 402a or the lever 402b of FIG. 4). The lever 402 rotates a first rotatable shaft 702 about a first axis 704, as indicated by the arrows 706. In some embodiments, the lever 402 rotates a second rotatable shaft 708 around a second axis 710, as indicated by the arrows 712. In some embodiments, the first axis 704 is orthogonal to the second axis 710. In some embodiments, the sensor 314 senses rotation of the shaft 702 and/or the shaft 708. The output generated by the sensor 314 (e.g., in response to the rotation of the shaft 702 and/or the shaft 708) is received by the processor(s) 302. The processor(s) 302 determine an amount of rotation of the shaft 702 and/or the shaft 708 based on the output of the sensor 314.

In some embodiments, to adjust a resistance force of input device 310 about the axis 704, a resistance force provided by the resistance assembly 720 is adjusted. For example, the resistance force provided by the resistance assembly 720 is adjusted in accordance with wind data (e.g., wind data determined by the processor 302 and/or received from movable object 102). In some embodiments, the processor 302 sends an instruction to the resistance assembly 720 to adjust a resistance to the rotation of the shaft 702 about the axis 704 (e.g., by increasing the resistance or decreasing the resistance).

In some embodiments, to adjust a resistance force of input device 310 about the axis 710, a resistance force provided by the resistance assembly 722 is adjusted. For example, the resistance force provided by the resistance assembly 722 is adjusted in accordance with wind data (e.g., wind data determined by the processor 302 and/or received from movable object 102). In some embodiments, the processor 302 sends an instruction to the resistance assembly 722 to adjust a resistance to the rotation of the shaft 708 about the axis 710.

In some embodiments, the resistance assembly 720 and/or the resistance assembly 722 include an actuator, such as a brake, a motor, and/or an electromagnetic device. In some embodiments, the resistance assembly 720 and/or the resistance assembly 722 include a mechanical resistance component, such as an elastic damping component, a friction braking component, a spring (e.g., a compression spring, a tension spring, and/or a torsion spring), a metal friction component, and/or an elastic and/or plastic deformation component. In some embodiments, the adjustment to the resistance produced by the resistance assembly 720 and/or the resistance assembly 722 is related to the magnitude and/or direction of wind as indicated by the wind direction data.

In some embodiments, the input device 310 includes a first reset member 726 that applies a restoring force to the shaft 702 to urge the shaft 702 toward an initial position of the shaft 702 (e.g., to return the shaft 702 to the initial position when the lever 402 is released after operation). In some embodiments, the input device 310 includes a second reset member 728 that applies a restoring force to the shaft 708 to urge the shaft 708 toward an initial position of the shaft 708 (e.g., to return the shaft 708 to the initial position when the lever 402 is released after operation).

In some embodiments, the first reset member 726 and/or the second reset member 728 include a damping device (e.g., elastic, oil, pneumatic, and/or hydraulic damper). In some embodiments, the first reset member 726 and/or the second reset member 728 include a spring (e.g., a compression spring, a tension spring, and/or a torsion spring).

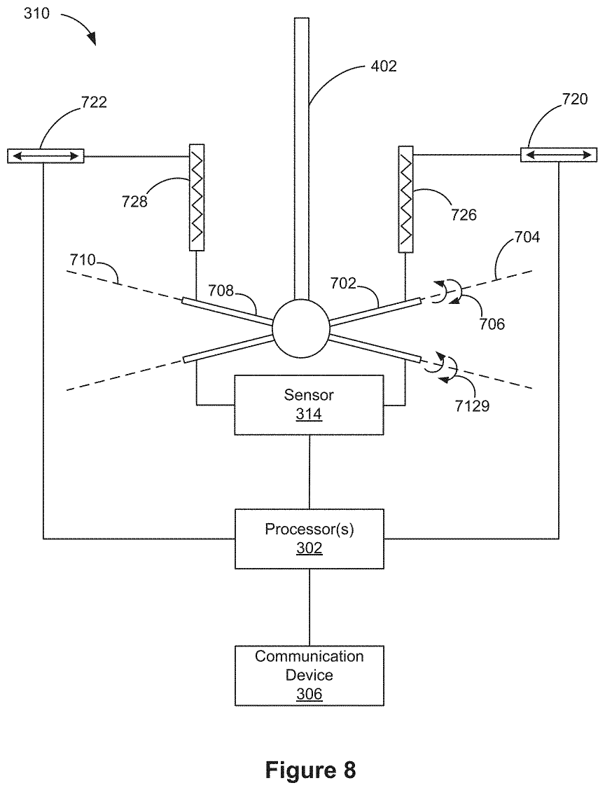

FIG. 8 illustrates an input device 310 in which the resistance assembly 720 is coupled to the reset member 726, in accordance with some embodiments. In some embodiments, the resistance assembly 722 is coupled to the reset member 728. To adjust the feedback (e.g., a resistance force) of input device 310 about the axis 704, a resistance force provided by the resistance assembly 720 is adjusted. To adjust the feedback (e.g., a resistance force) of input device 310 about the axis 710, a resistance force provided by the resistance assembly 722 is adjusted. The first reset member 726 applies a restoring force to the shaft 702 to urge the shaft 702 toward an initial position of the shaft 702. The second reset member 728 applies a restoring force to the shaft 708 to urge the shaft 708 toward an initial position of the shaft 708.

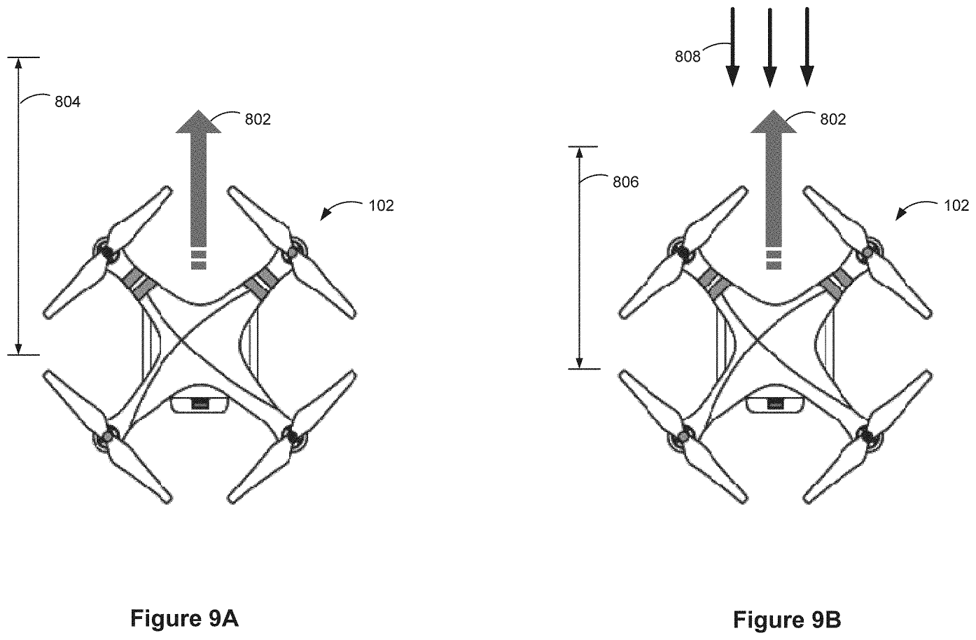

FIGS. 9A-9B illustrate the difference between an expected movement trajectory of the movable object 102 and an actual movement trajectory of the movable object 102 when the movable object 102 is flying into a headwind (e.g., the direction of movement of the movable object 102 is against the direction of movement of the wind). In FIGS. 9A-9B, movable object 102 is moving along a path indicated by the arrow 802.

In FIG. 9A, an expected movement trajectory of the movable object 102 in the absence of wind is illustrated at 804. The expected movement trajectory 804 is determined, e.g., based on power delivered to one or more actuators 212 of the movable object 102 and/or based on control instructions for movable object 102.

In FIG. 9B, an actual movement trajectory of the movable object 102 is illustrated at 806. The direction of wind in which the movable object 102 is flying is indicated by the arrows 808. The actual movement trajectory 806 is determined, e.g., based on the output of one or more sensors of the sensing system 210.

As illustrated in FIGS. 9A-9B, when the movable object 102 is flying into a headwind indicated at 808, the expected movement trajectory 804 of the movable object 102 is greater than the actual movement trajectory 806 of the movable object 102, because the movable object 102 must use more power to travel against the wind and thus travels less than the movable object 102 would travel in the absence of wind.

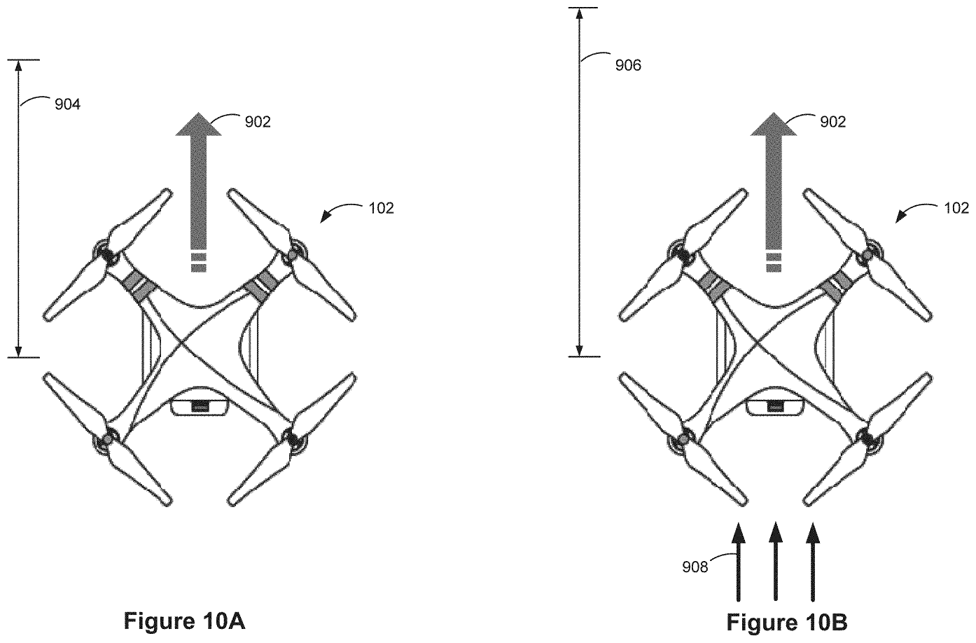

FIGS. 10A-10B illustrate the difference between an expected movement trajectory of the movable object 102 and an actual movement trajectory of the movable object 102 when the movable object 102 is flying in a tailwind (e.g., the direction of movement of the wind is in the direction of movement of the movable object 102). In FIGS. 10A-10B, movable object 102 is moving along a path indicated by the arrow 902.

In FIG. 10A, an expected movement trajectory of the movable object 102 in the absence of wind is illustrated at 904. The expected movement trajectory 904 is determined, e.g., based on power delivered to one or more actuators 212 of the movable object 102 and/or based on control instructions for the movable object 102.

In FIG. 10B, an actual movement trajectory of the movable object 102 is illustrated at 906. The direction of wind in which the movable object 102 is flying is indicated by the arrows 908. The actual movement trajectory 906 is determined, e.g., based on the output of one or more sensors of the sensing system 210. Because the movable object 102 is flying in a tailwind, the expected movement trajectory 904 of the movable object 102 is less than the actual movement trajectory 906 of the movable object 102. The wind 908 propels the moveable object 102 in its direction of travel 902, and thus the movable object 102 travels further in its direction of travel than the movable object 102 would travel in the absence of wind 908.

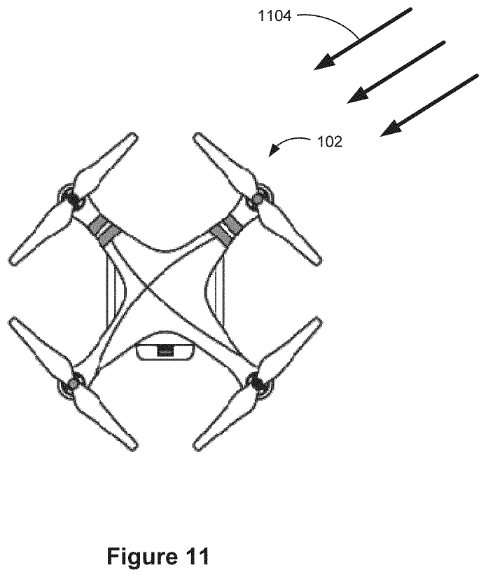

FIG. 11 illustrates wind incident on the movable object 102 that affects the movement trajectory of the movable object 102 along multiple axes, in accordance with some embodiments. The direction of wind in which the movable object 102 is flying is indicated by the arrows 1104.

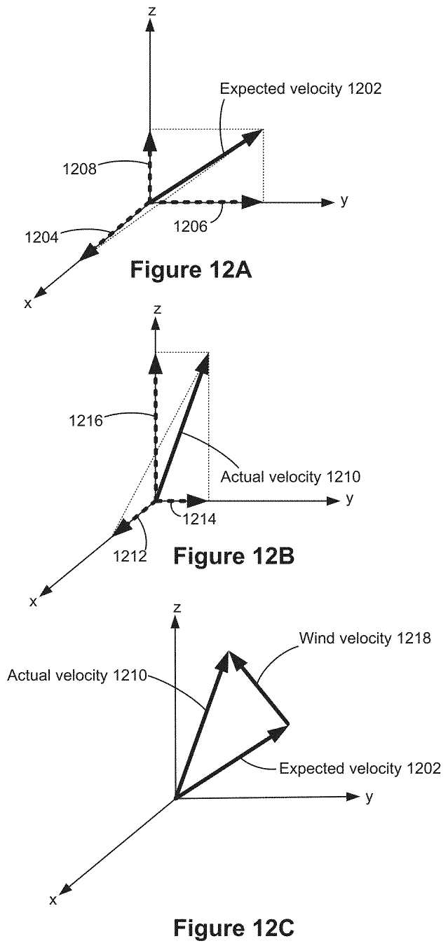

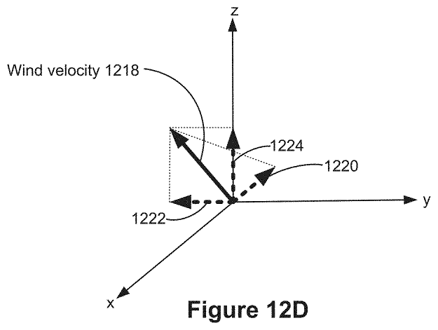

In some embodiments, to obtain data about the wind in which movable object 102 is flying, as indicated by the arrows 1104, an expected velocity of the movable object 102 is compared with an actual velocity of the movable object 102, as discussed with regard to FIGS. 12A-12D.

FIGS. 12A-12D illustrate use of an expected status parameter (such as an expected movement trajectory) and an actual status parameter (such as an actual movement trajectory) to obtain wind data (e.g., information about wind incident on the movable object 102, such as a velocity of the wind), in accordance with some embodiments.

In FIG. 12A, an expected velocity vector of the movable object 102 is indicated by the arrow 1202 relative to an x-axis, y-axis, and z-axis of the movable object 102 (e.g., the axes have an origin point centered on the centroid of the movable object 102). An x-axis component of the expected velocity vector is indicated by the arrow 1204 (e.g., the projection of expected velocity vector 1202 onto the x-axis). A y-axis component of the expected velocity vector is indicated by the arrow 1206. A z-axis component of the expected velocity vector is indicated by the arrow 1208.

In FIG. 12B, an actual velocity vector of the movable object 102 is indicated by the arrow 1210. An x-axis component of the expected velocity vector is indicated by the arrow 1212. A y-axis component of the expected velocity vector is indicated by the arrow 1214. A z-axis component of the expected velocity vector is indicated by the arrow 1216.

In some embodiments, wind data is determined by comparing the expected velocity vector 1202 of the movable object 102 with the actual velocity vector 1204 of the movable object 102. For example, in FIG. 12C, the magnitude and direction of wind incident on the movable object 102 is indicated by wind velocity vector 1218, which represents the difference in coordinate space between expected velocity vector 1202 and actual velocity vector 1210. In some embodiments, a magnitude of an adjustment to the feedback of an input device 310 corresponds to a magnitude of wind velocity vector 1218.

FIG. 12D indicates projection of the wind velocity vector 1218 onto the x-axis (as indicated by arrow 1220), the y-axis (as indicated by arrow 1224) and the z-axis (as indicated by arrow 1226). In some embodiments, a magnitude of an adjustment to the feedback of a first input device 310 (e.g., 310a) along a first axis (e.g., a vertical axis as described with regard to FIGS. 5A-5B) corresponds to a magnitude of the x-axis component 1220 of the wind velocity vector 1218. In some embodiments, a magnitude of an adjustment to the feedback of a first input device 310 (e.g., 310a) along a second axis (e.g., a horizontal axis as described with regard to FIGS. 5C-5D) corresponds to a magnitude of the y-axis component 1222 of the wind velocity vector 1218. In some embodiments, a magnitude of an adjustment to the feedback of a second input device 310 (e.g., 310b) along an axis (e.g., a vertical axis as described with regard to FIGS. 5E-5F) corresponds to a magnitude of the z-axis component 1224 of the wind velocity vector 1218.

The adjustment to the feedback of input device 310 provides the user with an indication of the effect wind will have control provided via the input device 310. In some embodiments, feedback is provided along multiple axes (e.g., vertical axis and horizontal axis of the input device 310) and/or at multiple input devices (310a and/or 310b) simultaneously.

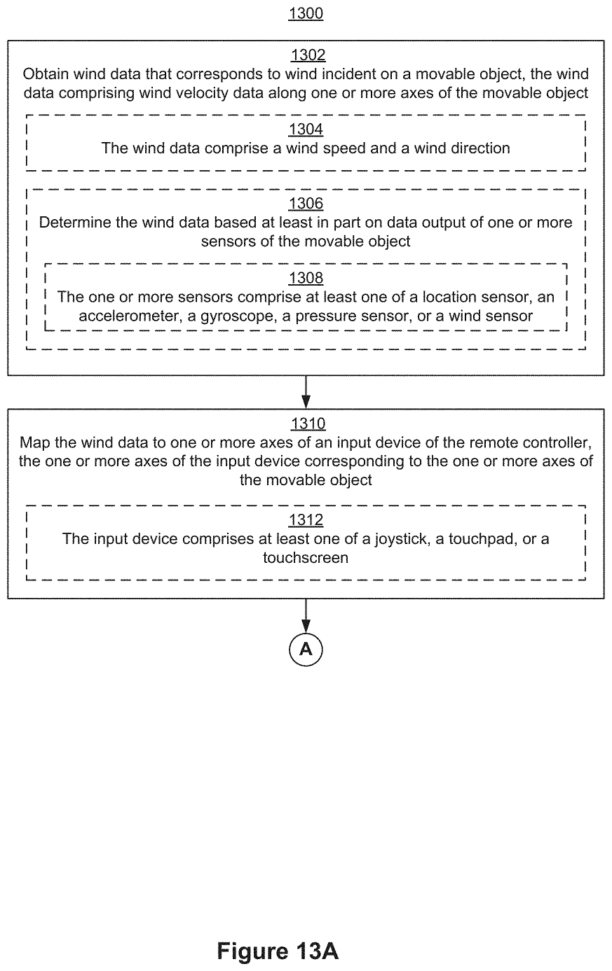

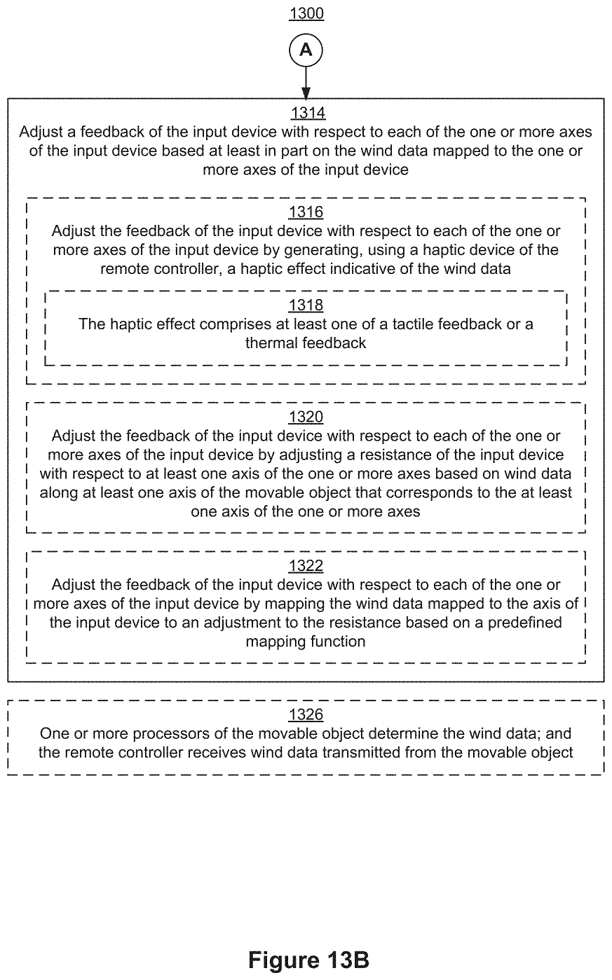

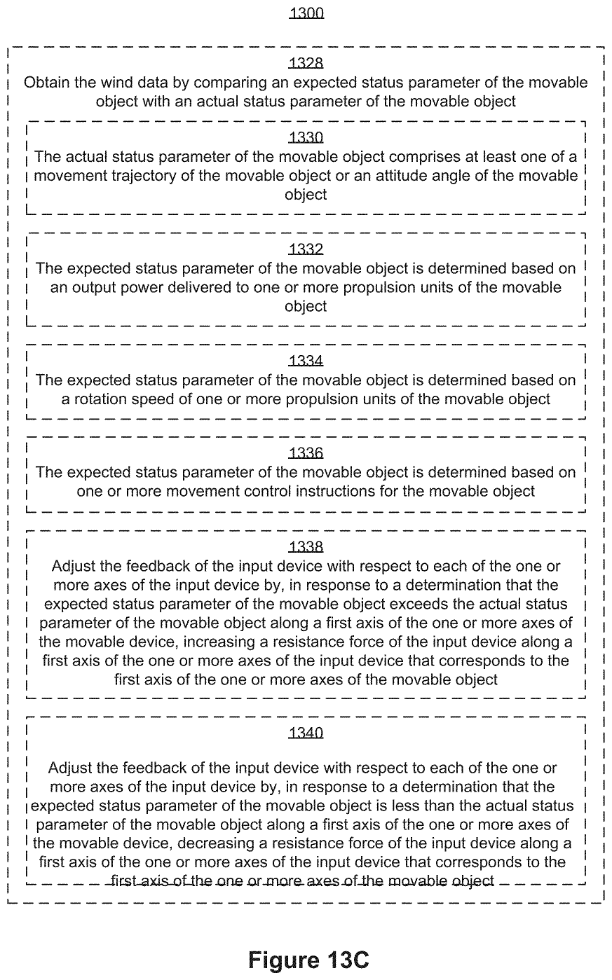

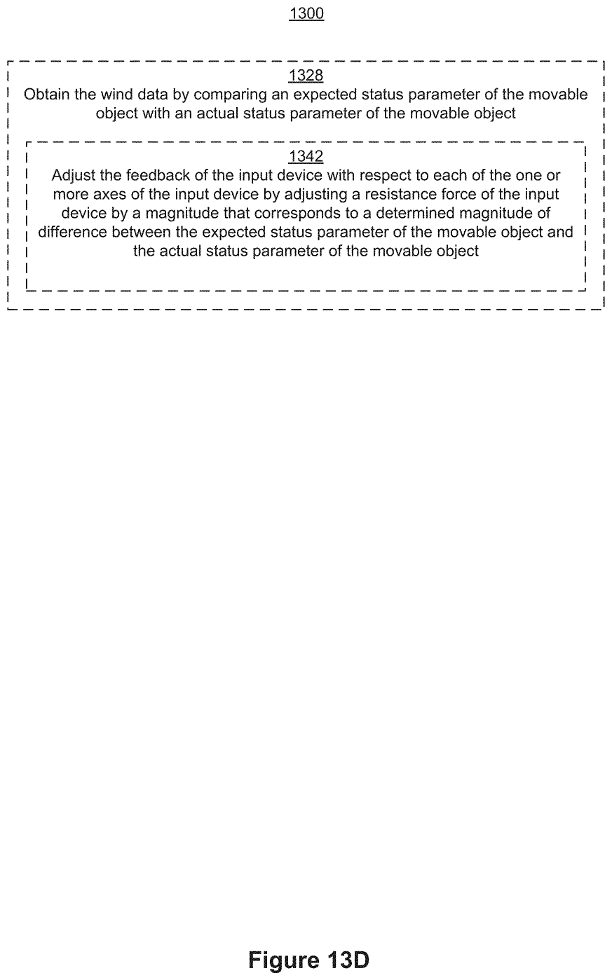

FIGS. 13A-13D are flow diagrams illustrating a method 1300 for adjusting feedback of a remote controller 108 that is configured to control movement of a movable object 102, in accordance with some embodiments. The method 1300 is performed at a device, such as the remote controller 108, the computing device 110, and/or the movable object 102. For example, instructions for performing the method 1300 are stored in the memory 304 and executed by the processor(s) 302 of the remote controller 108. In some embodiments, some or all of the instructions for performing the method 1300 are stored in the memory 204 and executed by the processor(s) 202 of the movable object 102.

The device obtains (1302) wind data that corresponds to wind incident on the movable object 102. The wind data includes wind velocity data along one or more axes of the movable object (e.g., the x-axis component of the wind velocity, as indicated by arrow 1220 of FIG. 12D, the y-axis component of the wind velocity, as indicated by arrow 1222, the z-axis component of the wind velocity, as indicated by arrow 1224, and/or total wind velocity as indicated by wind velocity vector 1218).

In some embodiments, the wind data comprise (1304) a wind speed (e.g., a magnitude of wind velocity as indicated by a length of wind velocity vector 1218 and/or a length of one or more components of wind velocity vector 1218, e.g., as indicated by arrows 1220, 1222, and/or 1224) and a wind direction (e.g., a direction of wind velocity vector 1218).

In some embodiments, the device determines the wind data based at least in part on (1306) data output of one or more sensors (e.g., one or more sensors of movable object sensing system 210) of the movable object 102.

In some embodiments, the one or more sensors comprise at least one of (1308) a location sensor (e.g., a Global Positioning System sensor), an accelerometer, a gyroscope, a pressure sensor, or a wind sensor.

The device maps (1310) the wind data to one or more axes of an input device 310 of the remote controller (e.g., a vertical axis of input device 310a as described with regard to FIGS. 5A-5B, a horizontal axis of input device 310a as described with regard to FIGS. 5C-5D, and/or a vertical axis of input device 310b as described with regard to FIGS. 5E-5F). The one or more axes of the input device 310 correspond to the one or more axes of the movable object 102.

In some embodiments, the input device 310 comprises (1312) at least one of a joystick (e.g., as shown at 402a and/or 402b of FIG. 4 and/or 402 of FIGS. 6-8), a touchpad, or a touchscreen (e.g., as described with regard to 308 of FIGS. 3-4).

The device adjusts (1314) a feedback of the input device 310 with respect to each of the one or more axes (e.g., a vertical axis of input device 310a as described with regard to FIGS. 5A-5B, a horizontal axis of input device 310a as described with regard to FIGS. 5C-5D, and/or a vertical axis of input device 310b as described with regard to FIGS. 5E-5F) of the input device 310 based at least in part on the wind data mapped to the one or more axes of the input device 310. For example, feedback based on the x-axis component of a wind velocity vector (e.g., as indicated by arrow 1220 of FIG. 12D) is applied along the vertical axis of input device 310a of remote controller 108.

In some embodiments, the device adjusts the feedback of the input device 310 with respect to each of the one or more axes of the input device by generating (1316), using a haptic device (e.g., a feedback device 316 that includes a haptic device) of the remote controller 108, a haptic effect indicative of the wind data.

In some embodiments, the haptic effect comprises (1318) at least one of a tactile feedback or a thermal feedback.

In some embodiments, the device adjusts the feedback of the input device 310 with respect to each of the one or more axes of the input device 310 by adjusting (1320) a resistance of the input device 310 with respect to at least one axis of the one or more axes based on wind data along at least one axis of the movable object that corresponds to the at least one axis of the one or more axes. In some embodiments, a resistance of the input device 310 is adjusted by altering an electrical current flowing through an electromagnetic coil 612, as described with regard to FIGS. 6A-6C. In some embodiments, a resistance of the input device 310 is adjusted by an instruction received by a resistance assembly 720 and/or resistance assembly 722 as described with regard to FIGS. 7-8.

In some embodiments, the device adjusts the feedback of the input device 310 with respect to each of the one or more axes of the input device 310 by (1322) mapping the wind data mapped to the axis of the input device to an adjustment to the resistance based on a predefined mapping function. For example, a predefined mapping function is a linear, exponential, or step function (e.g., that defines the relationship between wind speed and resistance adjustment magnitude).

In some embodiments (1326), one or more processors 202 of the movable object 102 determine the wind data and the remote controller 108 receives (e.g., via communication device 306) wind data transmitted (e.g., via communication device 206) from the movable object 102.

In some embodiments, the device obtains the wind data by (1328) comparing an expected status parameter of the movable object 102 with an actual status parameter of the movable object 102. For example, the expected status parameter is an expected velocity vector 1202 of movable object 102, the actual status parameter is an actual velocity vector 1210 of movable object 102, and the wind data includes wind velocity vector 1218 obtained by comparing expected velocity vector 1202 with actual velocity vector 1210, as described with regard to FIGS. 12A-12D.

In some embodiments, the actual status parameter of the movable object 102 comprises (1330) at least one of a movement trajectory of the movable object 102 or an attitude angle of the movable object 102.

In some embodiments, the expected status parameter of the movable object 102 is determined (1332) based on an output power delivered (e.g., by one or more actuators, such as the actuator 212a and/or the actuator 212b) to one or more propulsion units (e.g., movement mechanisms 114a and/or 114b) of the movable object.

In some embodiments, the expected status parameter of the movable object is determined (1334) based on a rotation speed of one or more propulsion units (e.g., movement mechanisms 114a and/or 114b) of the movable object 102.

In some embodiments, the expected status parameter of the movable object 102 is determined (1336) based on one or more movement control instructions for the movable object 102 (e.g., control instructions generated by the remote controller 108 based on input received at input device 310 and/or control instructions automatically determined by the remote controller 108 based on tracking instructions and/or instructions for a predetermined route). In some embodiments, the movable object 102 determines movement control instructions for controlling its own movement automatically (e.g., when tracking or following a preprogramed route or to avoid collision with an object) and the movable object 102 provides data indicating the control instructions to remote controller 108.

In some embodiments, the device adjusts the feedback of the input device 310 with respect to each of the one or more axes of the input device 310 by (1338), in response to a determination that the expected status parameter of the movable object 102 exceeds the actual status parameter of the movable object 102 along a first axis of the one or more axes of the movable device, increasing a resistance force of the input device 310 along a first axis of the one or more axes of the input device 310 that corresponds to the first axis of the one or more axes of the movable object 102. For example, in response to a determination that the length of x-axis component 1204 of expected velocity vector 1202 exceeds the length of x-axis component 1212 of actual velocity vector 1210, a resistance force is increased along a vertical axis of input device 310a, as discussed with regard to FIGS. 5A-5B. In this way, a resistance force along a vertical axis of input device 310a provides an indication of wind resistance to motion of movable object 102 along the x-axis.

In some embodiments, the device adjusts the feedback of the input device 310 with respect to each of the one or more axes of the input device 310 by (1340), in response to a determination that the expected status parameter of the movable object 102 is less than the actual status parameter of the movable object 102 along a first axis of the one or more axes of the movable device 102, decreasing a resistance force of the input device 310 along a first axis of the one or more axes of the input device 310 that corresponds to the first axis of the one or more axes of the movable object 102. For example, in response to a determination that the length of z-axis component 1208 of expected velocity vector 1202 is less than the length of z-axis component 1216 of actual velocity vector 1210, a resistance force is decreased along a vertical axis of input device 310b, as discussed with regard to FIGS. 5E-5F. In this way, a resistance force along a vertical axis of input device 310b provides an indication of wind resistance to motion of movable object 102 along the z-axis.

In some embodiments, the device adjusts the feedback of the input device 310 with respect to each of the one or more axes of the input device 310 by (1342) adjusting a resistance force of the input device 310 by a magnitude that corresponds to a determined magnitude of difference between the expected status parameter of the movable object 102 and the actual status parameter of the movable object 102. For example, a resistance force is increased along a vertical axis of input device 310a, as discussed with regard to FIGS. 5A-5B, by a magnitude that corresponds to a difference between the length of x-axis component 1204 of expected velocity vector 1202 and the length of x-axis component 1212 of actual velocity vector 1210 (this magnitude is illustrated by x-axis component 1220 of the wind velocity vector 1218 illustrated in FIG. 12D).

Many features of the present disclosure can be performed in, using, or with the assistance of hardware, software, firmware, or combinations thereof. Consequently, features of the present disclosure may be implemented using a processing system. Exemplary processing systems (e.g., processor(s) 202 and 302) include, without limitation, one or more general purpose microprocessors (for example, single or multi-core processors), application-specific integrated circuits, application-specific instruction-set processors, field-programmable gate arrays, graphics processing units, physics processing units, digital signal processing units, coprocessors, network processing units, audio processing units, encryption processing units, and the like.

Features of the present disclosure can be implemented in, using, or with the assistance of a computer program product, such as a storage medium (media) or computer readable storage medium (media) having instructions stored thereon/in which can be used to program a processing system to perform any of the features presented herein. The storage medium (e.g., memory 204 and 304) can include, but is not limited to, any type of disk including floppy disks, optical discs, DVD, CD-ROMs, microdrive, and magneto-optical disks, ROMs, RAMs, EPROMs, EEPROMs, DRAMs, VRAMs, DDR RAMs, flash memory devices, magnetic or optical cards, nanosystems (including molecular memory ICs), or any type of media or device suitable for storing instructions and/or data.

Stored on any one of the machine readable medium (media), features of the present disclosure can be incorporated in software and/or firmware for controlling the hardware of a processing system, and for enabling a processing system to interact with other mechanism utilizing the results of the present disclosure. Such software or firmware may include, but is not limited to, application code, device drivers, operating systems, and execution environments/containers.

Communication devices as referred to herein (e.g., communication devices 206 and 306) optionally communicate via wired and/or wireless communication connections. For example, communication devices optionally receive and send RF signals, also called electromagnetic signals. RF circuitry of the communication devices convert electrical signals to/from electromagnetic signals and communicate with communications networks and other communications devices via the electromagnetic signals. RF circuitry optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. Communication devices optionally communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. Wireless communication connections optionally use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSDPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 102.11a, IEEE 102.11ac, IEEE 102.11ax, IEEE 102.11b, IEEE 102.11g and/or IEEE 102.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

While various embodiments of the present disclosure have been described above, it should be understood that they have been presented by way of example, and not limitation. It will be apparent to persons skilled in the relevant art that various changes in form and detail can be made therein without departing from the spirit and scope of the disclosure.

The present disclosure has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the disclosure.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the invention be defined by the following claims and their equivalence.

What is claimed is:

1. A method for adjusting feedback of a remote controller configured to control movement of a movable object, the method comprising:
obtaining wind data that corresponds to wind incident on the movable object, the wind data comprising wind velocity data along one or more axes of the movable object;
mapping the wind data to one or more axes of an input device of the remote controller, the one or more axes of the input device corresponding to the one or more axes of the movable object; and
adjusting a feedback of the input device with respect to one of the one or more axes of the input device based at least in part on the wind data mapped to the one or more axes of the input device.

2. The method of claim 1, wherein the wind data comprises a wind speed and a wind direction.

3. The method of claim 1, wherein the wind data is determined based at least in part on data output of one or more sensors of the movable object.

4. The method of claim 3, wherein the one or more sensors comprise at least one of a location sensor, an accelerometer, a gyroscope, a pressure sensor, or a wind sensor.

5. The method of claim 1, wherein obtaining the wind data comprises comparing an expected status parameter of the movable object with an actual status parameter of the movable object.

6. The method of claim 5, wherein the actual status parameter of the movable object comprises at least one of a movement trajectory of the movable object or an attitude angle of the movable object.

7. The method of claim 5, wherein the expected status parameter of the movable object is determined based on at least one of:
an output power delivered to one or more propulsion units of the movable object,
a rotation speed of one or more propulsion units of the movable object, or
one or more movement control instructions for the movable object.

8. The method of claim 5, wherein adjusting the feedback of the input device with respect to the one of the one or more axes of the input device comprises at least one of:
in response to a determination that the expected status parameter of the movable object exceeds the actual status parameter of the movable object along one of the one or more axes of the movable device that corresponds to the one of the one or more axes of the input device, increasing a resistance force of the input device along the one of the one or more axes of the input device, or
in response to a determination that the expected status parameter of the movable object is less than the actual status parameter of the movable object along the one of the one or more axes of the movable device, decreasing the resistance force of the input device along the one of the one or more axes of the input device.

9. The method of claim 5, wherein adjusting the feedback of the input device with respect to the one of the one or more axes of the input device comprises adjusting a resistance force of the input device along the one of the one or more axes of the input device by a magnitude that corresponds to a determined magnitude of difference between the expected status parameter of the movable object and the actual status parameter of the movable object along one of the one or more axes of the movable object that corresponds to the one of the one or more axes of the input device.

10. The method of claim 1, wherein adjusting the feedback of the input device with respect to the one of the one or more axes of the input device comprises generating, by a haptic device of the remote controller, a haptic effect indicative of the wind data.

11. The method of claim 10, wherein the haptic effect comprises at least one of a tactile feedback or a thermal feedback.

12. The method of claim 1, wherein adjusting the feedback of the input device with respect to the one of the one or more axes of the input device comprises mapping the wind data mapped to the one or more axes of the input device to an adjustment to a resistance based on a predefined mapping function.

13. The method of claim 1, wherein the input device comprises at least one of a joystick, a touchpad, or a touchscreen.

14. A system for adjusting feedback of a remote controller configured to control movement of a movable object, the system comprising:
one or more processors; and
memory coupled to the one or more processors and storing one or more programs for adjusting feedback of the remote controller, wherein the one or more programs are configured to be executed by the one or more processors, the one or more programs including instructions for:
obtaining wind data that corresponds to wind incident on the movable object, the wind data comprising wind velocity data along one or more axes of the movable object;
mapping the wind data to one or more axes of an input device of the remote controller, the one or more axes of the input device corresponding to the one or more axes of the movable object; and
adjusting a feedback of the input device with respect to one of the one or more axes of the input device based at least in part on the wind data mapped to the one or more axes of the input device.

15. The system of claim 14, wherein the wind data comprise a wind speed and a wind direction.

16. The system of claim 14, wherein the one or more processors receives wind data transmitted from the movable object.

17. The system of claim 14, wherein the wind data is determined based at least in part on data output of one or more sensors of the movable object.

18. The system of claim 14, wherein obtaining the wind data comprises comparing an expected status parameter of the movable object with an actual status parameter of the movable object.

19. The system of claim 14, wherein adjusting the feedback of the input device includes generating, by a haptic device of the remote controller, a haptic effect indicative of the wind data.

20. The system of claim 14, wherein adjusting the feedback with respect to the one of the one or more axes of the input device comprises adjusting a resistance of the input device along the one of the one or more axes of the input device based on wind data along one of the one or more axes of the movable object that corresponds to the one of the one or more axes of the input device.
